(19) United States
(12) Patent Application Publication
(10) Pub. No.: US 2018/0018941 A1
(43) Pub. Date: Jan. 18, 2018

(54) DISPLAY DEVICE, DISPLAY CONTROL METHOD, AND DISPLAY SYSTEM

(71) Applicant: CANON KABUSHIKI KAISHA, Tokyo (JP)

(72) Inventor: Kazuhiro Monden, Inagi-shi (JP)

(21) Appl. No.: 15/646,873

(22) Filed: Jul. 11, 2017

(30) Foreign Application Priority Data
Jul. 13, 2016 (JP) 2016-138204

(51) Int. Cl. G09G 5/12; G06F 3/14; G09G 3/00; G09G 3/36; G03B 21/00

(52) U.S. Cl. CPC G09G 5/12; G06F 3/1446; G09G 3/002; G09G 2320/08; G03B 21/006; G09G 2354/00; G09G 2360/04; G09G 3/36

(57) ABSTRACT

A projector includes a communication unit or a recording/reproducing unit which obtains content and a controller which displays content in accordance with a first reproduction condition so that an image of quality the same as quality of an image displayed by another projector which displays the content at the same timing is viewed when the communication unit or the recording/reproducing unit obtains content to be displayed by a plurality of projectors and which displays content in accordance with a second reproduction condition which is different from the first reproduction condition when the communication unit or the recording/reproducing unit obtains content to be displayed by the projector.

### BACKGROUND

### Field of the Disclosure

The present disclosure relates to a display device which displays images, a display control method, and a display system.

### Description of the Related Art

In recent years, a digital signage system using a display device has attracted attention. The digital signage system employs, in addition to a method for reproducing content by one display device (hereinafter referred to as “single reproduction” or “single display”), a method for reproducing single content in a multiple screen formed by combining a plurality of display devices (hereinafter referred to as “multiple synchronization reproduction”). Japanese Patent Laid-Open No. 2008-252422 discloses a technique of performing time synchronization among a plurality of display devices by transmitting time information of one of the display devices to the other display devices so that single content is displayed in a multiple screen.

In the technique disclosed in Japanese Patent Laid-Open. No. 2008-252422, it is assumed that single content is displayed in a multiple screen. However, in the digital signage system, different content may be displayed in different screens. In the multiple synchronization reproduction, an image in the multiple screen becomes defective if the display devices are not synchronized with one another in display. Therefore, the synchronization is importantly performed even if a frame is dropped. On the other hand, content to be reproduced differs among the different display devices in the single reproduction, and therefore, synchronization among the display devices is not required, and the individual display devices preferably reproduce the content in accordance with their own processing capabilities.

It is assumed here that a first display device has processing capability that can reproduce moving image data in a frame rate of 30 fps and a second display device has processing capability that can reproduce moving image data in a frame rate of 24 fps. When the multiple synchronization reproduction is performed in a frame rate of 30 fps on the moving image data using these display devices, the first display device performs a reproduction process in accordance with the capability of the second display device (that is, the reproduction is performed in the frame rate of 24 fps) so that timings of updating of video images match each other between the two display devices. However, if the first display device reproduces the moving image data to be reproduced in the frame rate of 30 fps in the frame rate of 24 fps even in a case of the single reproduction, display quality of the reproduced moving image data is excessively degraded. Therefore, in the general techniques, it is difficult to perform reproduction of moving image data suitable for both of the multiple synchronization reproduction and the single reproduction.

### SUMMARY

What is needed is an improvement in display quality in a display system including at least two display devices which display single content.

According to an embodiment of the present disclosure, a display device includes a content obtaining unit configured to obtain content, and a display controller configured to display, when the content obtaining unit obtains the content to be displayed by a plurality of display devices, the content in a display unit in accordance with a first reproduction condition so that an image of quality the same as quality of an image displayed by another display device which displays the content at the same timing is viewed, and to display, when the content obtaining unit obtains the content to be displayed by a display device, the content in the display unit in accordance with reproduction condition which is different from the first reproduction condition.

According to another embodiment of the present disclosure, a display control method includes obtaining content and displaying, when the content to be displayed by a plurality of display devices is obtained, the content in a display unit in accordance with a first reproduction condition so that an image of quality the same as quality of an image displayed by another display device which displays the content at the same timing is viewed, and displaying, when the content to be displayed by a display device is obtained, the content in the display unit in accordance with a second reproduction condition which is different from the first reproduction condition.

Further features of the present disclosure will become apparent from the following description of exemplary embodiments with reference to the attached drawings.

### BRIEF DESCRIPTION OF THE DRAWINGS

FIG. 1 is a diagram illustrating a configuration of a display system according to one or more aspects of the present disclosure.

FIG. 2 is a diagram illustrating a configuration of a projector according to one or more aspects of the present disclosure.

FIG. 3 is a diagram illustrating schedule information according to one or more aspects of the present disclosure.

FIG. 4 is a flowchart of a process of a coordinated operation between projectors according to one or more aspects of the present disclosure.

FIGS. 5A and 5B are diagrams illustrating schedule information recorded in recording media of the projectors according to one or more aspects of the present disclosure.

FIGS. 6A and 6B are diagrams illustrating images displayed by the projectors according to one or more aspects of the present disclosure.

FIG. 7 is a diagram illustrating a modification of the configuration of the display system according to one or more aspects of the present disclosure.

### DESCRIPTION OF THE EMBODIMENTS

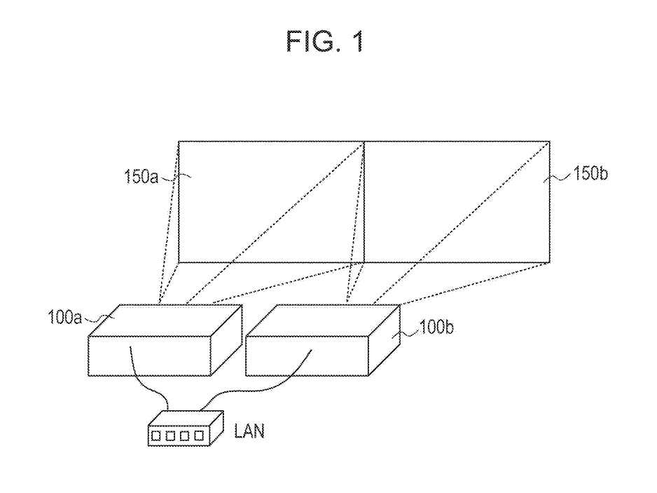

FIG. 1 is a diagram illustrating a configuration of a display system S according to an embodiment. The display system S includes two projectors 100 (100a and 100b) connected to the same network. The projectors 100 are examples of a display device and are liquid crystal projectors, for example. Each of the projectors 100 projects light which is emitted from a light source and which passes liquid crystal elements on a screen controlling light transmittance of the liquid crystal elements in accordance with an image to be displayed on a projection surface 150 so as to display the image for a user.

The projectors 100a and 100b have the same configuration and the same functions. The projectors 100a and 100b may transmit and receive data through the network between the projectors 100a and 100b. The projectors 100a and 100b may perform multiple projection for displaying single content (a still image or a moving image, for example) using a plurality of projection surfaces 150 (150a and 150b) by projecting an image on the projection surfaces 150 which are horizontally adjacent to each other. In a description below, when a configuration and functions which are common in the projectors 100a and 100b are to be described, the projectors 100a and 100b are referred to as a “projector 100” or “projectors 100”.

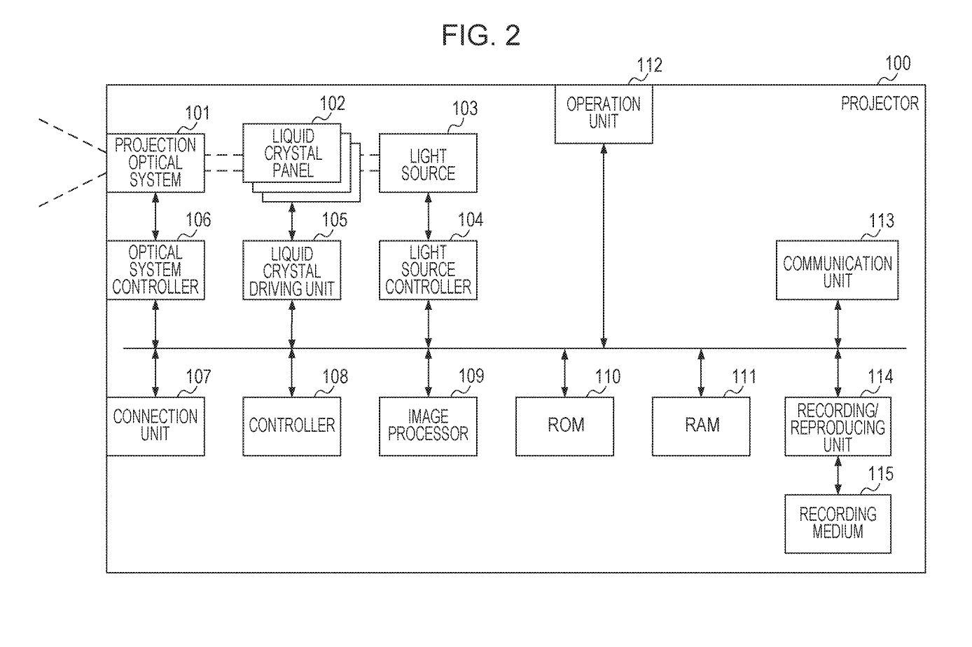

FIG. 2 is a diagram illustrating a configuration of the projector 100. The projector 100 includes a projection optical system 101, a liquid crystal panel 102, a light source 103, a light source controller 104, a liquid crystal driving unit 105, an optical system controller 106, a connection unit 107, a controller 108, an image processor 109, a read-only memory (ROM) 110, a random access memory (RAM) 111, an operation unit 112, a communication unit 113, a recording/reproducing unit 114, and a recording medium 115.

The projection optical system 101 is a display unit which projects an output image on a screen. The projection optical system 101 including a plurality of lenses and actuators for driving the lenses drives the lenses by the actuators so as to perform size-enlargement, size-reduction, focus adjustment, and the like on the projected image.

The liquid crystal panel 102 generates images dedicated for individual colors (red (R), green (G), and blue (B)) from light beams of the colors which are emitted from the light source 103 and which are separated from one another by a mirror (not illustrated).

The light source controller 104 controls an amount of light emitted by the light source 103 and controls ON and OFF of light emission in accordance with a control instruction supplied from the controller 108 described below.

The liquid crystal driving unit 105 controls transmittance of the liquid crystal panel 102 for reproducing the individual colors R, G, and B in accordance with an input video signal.

The optical system controller 106 controls a zoom factor, a shift amount, and focus of the projection optical system 101 in accordance with a control instruction supplied from the controller 108.

The connection unit 107 is an interface for connection to an external device, such as a video output device or a hard disk. The projector 100 performs transmission and reception of video signals, audio signals, and various control signals between the projector 100 and the external apparatus through the connection unit 107.

The controller 108 is a central processing unit (CPU), for example. The controller 108 issues instructions to the various units, manages an internal state of the projector 100, and manages a projection mode in accordance with programs stored in the ROM 110 described below. The controller 108 controls the light source controller 104, the liquid crystal driving unit 105, the optical system controller 106, and the image processor 109 so as to control reproduction conditions of content, such as a color tone, luminance, and a frame rate, at a time of display of the content. The reproduction conditions, such as a color tone, luminance, and a frame rate, at a time of display of the content affect a view of the content.

When the communication unit 113 or the recording/reproducing unit 114 obtains content for the multiple synchronization reproduction to be displayed in the plurality of projectors 100, the controller 108 of the projector 100a functions as a display control unit which displays the content in accordance with a first reproduction condition so that an image of quality the same as quality of an image of the projector 100b which is another display device is displayed. When the communication unit 113 or the recording/reproducing unit 114 obtains content for single display reproduction to be displayed in the projector 100, the controller 108 displays the content in accordance with a second reproduction condition which is different from the first reproduction condition.

The first reproduction condition is defined in accordance with setting values of a color tone, luminance, a frame rate, and the like which are set so that a view of one of the projectors 100a and 100b which has lower performance is realized, for example. The second reproduction condition is defined in accordance with setting values of a color tone, luminance, a frame rate, and the like which are set so that an excellent view of the projector 100a is realized by making the most of performance of the projector 100a, for example. The projector 100 may use, as setting values corresponding to the first reproduction condition and setting values corresponding to the second reproduction condition, setting values which are set in advance by the user and which are stored in a nonvolatile memory (the ROM 110, for example) or setting values which are determined in accordance with performance of the projector 100 or status information associated with an operation state.

The image processor 109 executes various processes including a resolution conversion process, a frame rate conversion process, an image shape deformation process, a color tone conversion process, an edge blend process, on-screen display (OSD), and an overlap process on an input image. The image processor 109 executes the image processing based on an instruction issued by the controller 108 in accordance with the first reproduction condition or the second reproduction condition.

The ROM 110 is a nonvolatile memory which stores programs to be executed by the controller 108 and table data to be constantly stored. The ROM 110 stores the first reproduction condition to be used in the multiple synchronization reproduction and the second reproduction condition to be used in the single reproduction.

The RAM 111 is a volatile memory to be used to temporarily store image data input through the connection unit 107 and image data to be used when the image processor 109 executes the image processing.

The operation unit 112 includes various operation buttons disposed on a case of the projector 100. The operation unit 112 is an operation interface for performing function control and a menu operation on the projector 100. The operation unit 112 functions as an input reception unit which receives an input of the setting values of the first reproduction condition when the projector 100 obtains the content for the multiple synchronization reproduction. The operation unit 112 stores the accepted setting values in the ROM 110 under control of the controller 108.

The communication unit 113 has an interface for communication with the external device through a communication network, such as a wired local area network (LAN) or a wireless LAN. The communication unit 113 functions as a first content, obtaining unit which obtains content, such as still image data or moving image data, from the external device. Furthermore, the communication unit 113 functions in a communication available manner with other projectors 100 and performs transmission and reception of information with the projectors 100. The projector 100a receives status information on a state of the projector 100b from the projector 100b when the projector 100b displays the content. The status information indicates a status of the projector 100 which affects a view of an image, such as luminance, a color tone, or a frame rate set when the projector 100 displays the content.

The recording/reproducing unit 114 functions as a second content obtaining unit which obtains the content, such as the still image data or the moving image data, stored in the recording medium 115 and which records the still image data or the moving image data in the recording medium 115 through the communication unit 113. The recording/reproducing unit 114 stores the content obtained by the recording medium 115 in the RAM 111.

The recording medium 115 is a recording medium employing an arbitrary method, such as a magnetic disk, an optical disc, or a semiconductor memory, which may record still image data, moving image data, control data to be used by the projector 100, and the like. The recording medium 115 may be a detachable recording medium or an incorporated recording medium.

### Basic Operation of Projector 100

Next, a basic operation of the projector 100 included in the digital signage system will be described. Here, as the basic operation, one projector reproduces and displays still image data or moving image data (hereinafter referred to as “content”) stored in a storage medium in accordance with a schedule set by the user. Note that an operation below is executed when the controller 108 included in the projector 100 executes a program stored in the ROM 110. It is assumed there that, in a description below, the program described above is activated in accordance with an instruction issued by the user.

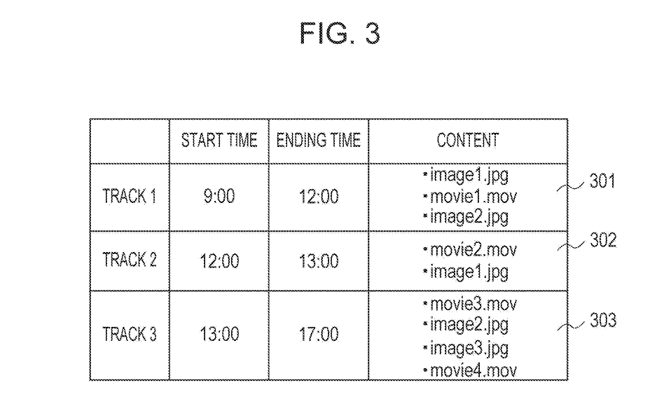

The controller 108 projects content selected from among a plurality of content on the projection optical system 101 in accordance with a predetermined schedule for projecting a plurality of content on the projection optical system 101. The controller 108 controls the recording/reproducing unit 114 so as to read schedule information from the recording medium 115. FIG. 3 is a diagram illustrating the schedule information. As illustrated in FIG. 3, a reproduction start time, a reproduction ending time, and reproduction target content are associated with one another in the schedule information. In this specification, schedule information in one unit including the reproduction start time, the reproduction ending time, and the reproduction target content which are associated with one another is referred to as a “track”.

A track 1 in an example of FIG. 3 indicates that content (image1.jpg, movie1.mov, and image2.jpg) described in a content column 301 is repeatedly reproduced in a time slot from 9:00 to 12:00. A track 2 indicates that content described in a content column 302 is repeatedly reproduced in a time slot from 12:00 to 13:00. A track 3 indicates that content described in a content column 303 is repeatedly reproduced in a time slot from 13:00 to 17:00.

Note that the data included in the schedule information is written in the recording medium 115 by the user, for example. The projector 100 may display an operation screen for setting a schedule after the recording medium 115 storing still image data or moving image data is inserted in the projector 100 and may store data input by the user as the schedule information.

At a content reproduction start time (“START TIME” in FIG. 3) of a first track recorded in the schedule, the controller 108 reads the content (“CONTENT” in FIG. 3) to be reproduced in this time slot from the recording medium 115 and temporarily stores the content in the RAM 111. Note that the projector 100 includes a time measurement unit (not illustrated) for measuring a current time, and the controller 108 obtains a current time from the time measurement unit.

The controller 106 reproduces one of the content stored in the RAM 111 in accordance with a program stored in the ROM 110. Thereafter, the controller 108 transmits the reproduced content to the image processor 109, causes the image processor 109 to execute a process of converting the number of pixels, a frame rate, and a shape of a video image, and transmits the image for one screen which has been subjected to the conversion process to the liquid crystal driving unit 105.

Subsequently, the controller 108 causes the liquid crystal driving unit 105 to control the liquid crystal panel 102 so that transmittance corresponding to gradation levels of color components of red (R), green (G), and blue (B) of the received image for one screen is obtained. Then the controller 108 causes the light source controller 104 to control output of light emitted from the light source 103. Light beams of the red (R), green (G), and blue (B) which have passed the liquid crystal panel 102 are projected on a screen, not illustrated, through the projection optical system 101.

Note that, when an instruction by the user who operates the projection optical system 101 is input from the operation unit 112, the controller 108 causes the optical system controller 106 to change focus of a projected image or control an actuator of the projection optical system 101 so that an enlargement ratio of the projection optical system 101 is changer.

According to the process described above, single content read in accordance with the schedule stored in the recording medium 115 is projected and displayed.

When the content which has been projected and displayed is still image data, the controller 108 performs a process of reproducing next content stored in the RAM 111 so that the same process is performed after a predetermined period of time has elapsed. Note that a period of time in which the controller 108 continues display of the same still image data may be described in the schedule or set by the projector 100. When the content which has been projected and displayed is moving image data, the controller 108 performs a process of reproducing next content stored in the RAM 111 so that the same process is performed after the reproduction of the moving image data is completed.

The controller 108 repeatedly performs the content reproduction projection process until the content reproduction ending time (“ENDING TIME” in FIG. 3) included in the read schedule information is reached. When the schedule information indicates that another track exists, the controller 108 reads content of the track from the recording medium 115 at a content reproduction start time (“START TIME” in FIG. 3) of the track so as to execute the same track reproduction process.

Note that the controller 108 may cause the light source controller 104 to start light emission from the light source 103 at the reproduction start time of the first track and to stop the light emission from the light source 103 at a reproduction ending time of a last track.

### Coordinated Operation of Projectors 100

Next, a coordinated operation of the projectors 100a and 100b will be described. As described above, the controller 108 performs switching between the first reproduction condition suitable for the multiple synchronization reproduction and the second reproduction condition suitable for the single reproduction in accordance with a type of content obtained by the communication unit 113 or the recording/reproducing unit 114. The controller 108 reproduces content in synchronization with another projector 100 using setting values corresponding to performance and a status of the other projector 100 in the multiple synchronization reproduction. On the other hand, the controller 108 reproduces content preferentially using display setting values of itself or setting values of display property associated with the content in the single reproduction.

For example, the controller 108 of the projector 100a uses a maximum frame rate of the projector 100b as a first frame rate when the maximum frame rate of the projector 100b is smaller than a maximum frame rate of the projector 100a. Furthermore, the controller 108 of the projector 100a uses the maximum frame rate of the projector 100a as a second frame rate when the communication unit 113 or the recording/reproducing unit 114 of the projector 100a obtains content for display in a projector.

Similarly, the controller 108 of the projector 100a causes the projection optical system 101 to project content of first image quality corresponding to the first reproduction condition when the communication unit 113 or the recording/reproducing unit 114 of the projector 100a obtains content to be displayed in a plurality of projectors. In this case, the controller 108 instructs the light source controller 104 to control an amount of light emitted from the light source 103 so that luminance values of the projectors 100a and 100b match each other by comparison with luminance information of the projector 100a. For example, when luminance of the projector 100b is lower than that of the projector 100a, the controller 108 of the projector 100a causes the projection optical system 101 to project the content with the luminance of the projector 100b.

Furthermore, the controller 108 causes the projection optical system 101 to project content of second image quality corresponding to the second reproduction condition when the communication unit 113 or the recording/reproducing unit 114 obtains content to be displayed in a projector. For example, the controller 108 of the projector 100a projects the content with maximum luminance usable in the projector 100a irrespective of the luminance of the projector 100b.

Note that the controller 108 may recognize a maximum frame rate and maximum luminance usable by the other projector 100 with reference to the schedule information described above and information on a status of the other projector 100 recorded in the recording medium 115, for example. The controller 108 may obtain information on the maximum frame rate and information on the maximum luminance from the other projector 100 through the communication unit 113.

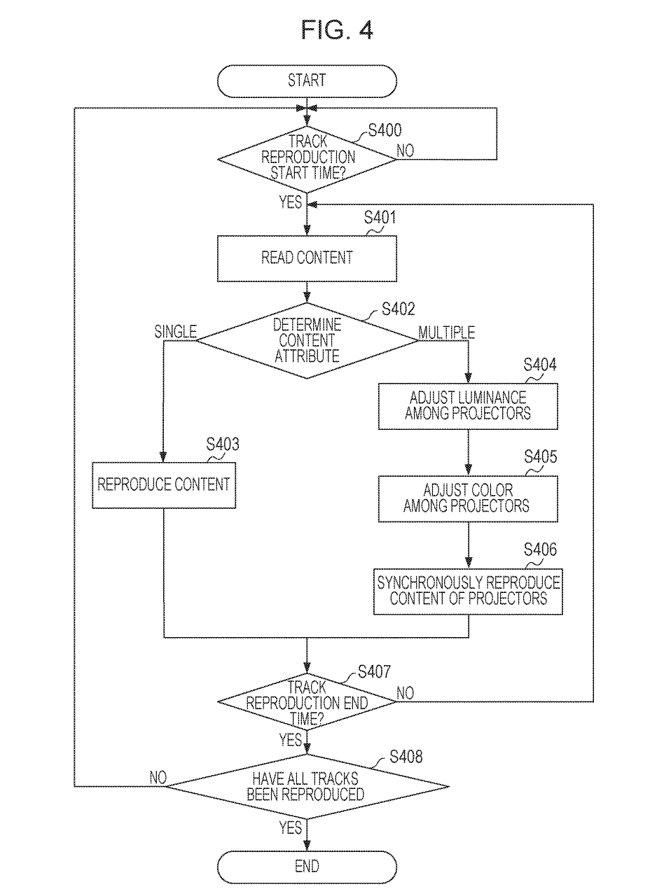

FIG. 4 is a flowchart of a process of the coordinated operation of the projectors 100a and 100b. The operation illustrated in FIG. 4 is executed when the controller 108 controls the various functional blocks in accordance with the programs stored in the ROM 110.

First, in step S400, the controller 108 causes the recording/reproducing unit 114 to develop the schedule recorded in the recording medium 115 in the RAM 111. Thereafter, the controller 108 waits until a reproduction start time of one of the tracks included in the schedule. At a reproduction start time of the track, the controller 108 determines the track as a reproduction target track and proceeds to step S401.

In step S401, the controller 108 causes the recording/reproducing unit 114 to select one of a plurality of content included in tine reproduction target track in a plurality of content stored in the recording medium 115. The controller 108 temporarily stores the selected content in the RAM 111 and proceeds to step S402. Note that the controller 108 may randomly select one of the plurality of content included in the track or may select one of the plurality of content in accordance with a reproduction order of the track indicated by supplemental information. Furthermore, the controller 108 may not develop all the content in the RAM 111, and may read the content in a unit of frame processible in a reproduction process described below when a size of the content is large such as a case of moving image data.

Subsequently, in step S402, the controller 108 determines whether the content recorded in the RAM 111 is content for the single reproduction or content for the multiple reproduction. When determining that the content recorded in the RAM 111 is for the single reproduction, the controller 108 proceeds to step S403, whereas when determining that the content is for the multiple reproduction, the controller 106 proceeds to step S404.

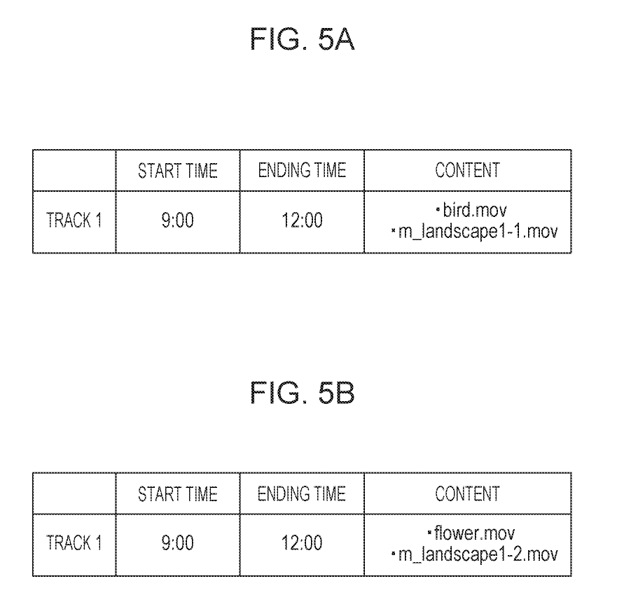

Here, a method employed in the process of determining a type of content will be described in detail. FIGS. 5A and 5B are diagrams illustrating the schedule information recorded in the recording medium 115 of the projectors 100. FIG. 5A is a diagram illustrating the schedule information recorded in the recording medium 115 of the projector 100a. FIG. 5B is a diagram illustrating the schedule information recorded in the recording medium 115 of the projector 100b. The schedule information defines that the content is reproduced in a time slot from 9:00 to 12:00.

As illustrated in FIG. 5A, the content to be reproduced by the projector 100a is moving image data “bird.mov” and moving image data “m_landscape1-1.mov”. As illustrated in FIG. 5B, the content to be reproduced by the projector 100b is moving image data “flower.mov” and moving image data “m_landscape1-2.mov”. A file having a prefix of a file name of “m_” indicates multiple reproduction content.

Since a naming rule of file names is defined in advance, the controller 108 may determine whether content is for the multiple synchronization reproduction or for the single reproduction in accordance with a file name of the content. Therefore, when the user determines a file name in accordance with the naming rule of content for the multiple reproduction or content for the single reproduction, the controller 108 may determine a type of a reproduction method suitable for the content and reproduces the content by the desired reproduction method.

Note that, although the case where the determination as to whether content to be displayed is for the single reproduction or for the multiple reproduction is made in accordance with a file name is described as an example in this embodiment, the controller 108 of the projector 100 may make the determination by discriminating a folder which stores content for the single reproduction from a folder which stores content for the multiple reproduction. Furthermore, the controller 108 may make the determination by setting a flag indicating content for the multiple reproduction in an extended region of the content. Alternatively, the controller 108 may make the determination by independently generating a table including attributes of content separately from the content and storing the table in the recording medium 115.

Referring back to FIG. 4, a process performed after the determination in step S402 is terminated will be described. When determining that the content to be displayed is for the single reproduction in step S402, the controller 108 executes a process of reproducing content for the single reproduction in accordance with a program stored in the ROM 110 in step S403. When the process is completed, the controller 108 proceeds to step S407. The controller 108 reproduces the content determined for the single reproduction in accordance with the reproduction condition for the single reproduction stored in the ROM 110. When the controller 108 determines that the content to be reproduced is for the single reproduction, the coordinated operation between the projectors 100 which form a multiple projection. surface is not performed. Accordingly, the projector 100 may perform a reproduction process corresponding to processing capability of the projector 100.

It is assumed here that the projector 100a is capable of performing moving image reproduction in a frame rate of 30 fps whereas the projector 100b is capable of performing moving image reproduction in a frame rate of 24 fps at maximum. It is further assumed that both of the single reproduction content “bird.mov” of FIG. 5A and the single reproduction content “flower.mov” of FIG. 5B are to be reproduced by the projectors 100a and 100b, respectively, in a frame rate of 30 fps.

Even in this case, the individual projectors 100 are capable of performing the respective processes corresponding to their capabilities, and therefore, the projector 100a performs moving image reproduction in the frame rate of 30 fps whereas the projector 100b performs moving image reproduction in the frame rate of 24 fps which is a processing limit of the projector 100b. Furthermore, since the projectors 100a and 100b do not perform luminance adjustment and color adjustment between the projectors 100a and 100b, the content may be displayed with luminance and color tones based on the setting values suitable for the respective projectors 100a and 100b.

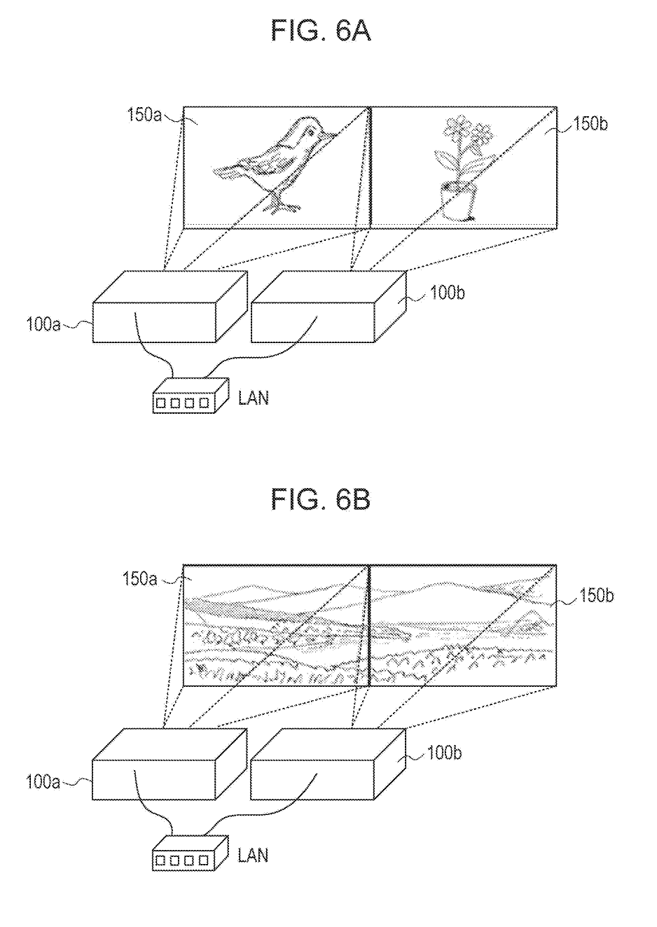

FIG. 6A is a diagram illustrating a state of the single reproduction performed by the projectors 100a and 100b. In FIG. 6A, content reproduced by the projector 100a is different from content reproduced by the projector 100b, and therefore, a viewer does not experience a feeling of strangeness even though the multiple synchronization reproduction is not performed. Therefore, when the process in step S403 is performed, the projectors 100a and 100b reproduce the content in accordance with the processing capabilities of the projectors 100a and 100b without the feeling of strangeness of the viewer.

On the other hand, when determining that content to be displayed in the plurality of projectors 100 is obtained in step S402, the controller 108 causes the projection optical system 101 to project the content in accordance with a reproduction condition suitable for processing capability of a counterpart projector 100. The controller 108 instructs the communication unit 113, in step S404 to step S406, for example, to obtain the status information indicating luminance, a color tone, a frame rate, and the like for display of content by the other projector 100b which forms the multiple projection surface from the projector 100b. The controller 108 displays the content in accordance with a reproduction condition determined in accordance with the obtained status information.

It is assumed here that the schedule information stored in the recording medium 115 of the projector 100a includes an IP address of the projector 100b serving as the counterpart projector 100 which forms the multiple projection surface. The controller 108 of the projector 100a reads the schedule information recorded in the recording medium 115 so as to recognize that the number of projectors 100 involved in the coordinated operation is one and recognize the IF address for communication with the coordinated projector 100. Furthermore, if an IP address of the projector 100a is described in the schedule information stored in the recording medium 115 of the projector 100b, the communication may be performed while a counterpart projector of the coordinated operation of each of the projectors 100 is identified.

In step S404, the controller 108 causes the communication unit 113 to collect luminance information of the other projector 100 forming the multiple projection surface. Then the controller 108 compares the collected luminance information with luminance information of the projector 100 of the controller 108 and controls the light source 103 and the light source controller 104 so that the luminance between the projectors 100 matches. Subsequently, in step S405, the controller 108 causes the communication unit 113 to collect color information of the counterpart projector 100 which forms the multiple projection surface. Then the controller 108 causes the image processor 109 to perform the color tone conversion so that color tones of the projectors 100 match each other with reference to color information of the projector 100 of the controller 108 before proceeding to step S406. Since both of the projectors 100a and 100b perform the process in step S404 and step S405, luminance values and color tones match in the entire multiple projection surface.

In step S406, the controller 108 executes a process of synchronizing content reproduction between the projectors 100 which form the multiple projection surface, and proceeds to step S407 when the process is completed. In step S407, the controller 108 performs time synchronization with the counterpart projector 100 before causing the projection optical system 101 to project the content.

When performing synchronization reproduction on moving image data to be reproduced, the controller 108 instructs the communication unit 113 to accurately perform the time synchronization process before start of the reproduction. The controller 108 performs the time synchronization using a network time protocol (NTP), for example. Then the controllers 108 of the projectors 100 realize the synchronization reproduction of the moving image data by starting the reproduction of the moving image data stored in the respective RAMs 111 at a reproduction start time of the content.

When the capabilities for processing the moving image data of the projectors 100 are different from each other, the controller 108 causes the communication unit 113 to obtain information indicating the processing capability of the counterpart projector 100 so as to compare the processing capability of the counterpart projector 100 with the processing capability of the projector 100 of the controller 108. The controller 108 may execute a reproduction process while some frames are omitted so that the processing capabilities of the individual projectors 100 match each other.

When performing the synchronization reproduction on still image data, the controller 108 of the projector 100 may cause the communication unit 113 to determine one of the projectors serving as a master of a counterpart projector 100. At the reproduction start time of the content, the controllers 108 of the individual projectors 100 perform a decoding process on the still image data stored in the RAM 111 in accordance with a program stored in the ROM 110. The controller 108 of the projector 100 (the projector 100b, for example) other than the master notifies the projector 100 (the projector 100a) serving as the master of completion of the decoding through the communication unit 113.

The controller 108 of the projector 100a serving as the master transmits an instruction for displaying the content to the projector 100b before causes the projection optical system 101 to project the content. For example, the controller 108 of the projector 100a waits until completion of the decoding of the projector 100a and reception of the decoding completion notification supplied from the projector 100b through the communication unit 113 after transmitting the instruction for displaying the content to the projector 100b. The controller 108 of the projector 100a instructs the image processor 109 to display a result of the decoding of the projector 100a when the decoding of the projectors 100a and 100b is completed. Furthermore, the controller 108 of the projector 100a causes the communication unit 113 to instruct the counterpart projector 100b to display a decoding result.

The controller 108 of the projector 100b controls the communication unit 113 so as to wait until reception of the instruction for displaying the decoding result. The controller 108 of the projector 100b causes the image processor 109 to execute the display of the decoding result when receiving the display instruction. In this way, the synchronization reproduction of still image data is executed.

FIG. 6B is a diagram illustrating the multiple reproduction. In this case, single content is formed by connecting reproduced content of the projector 100a and reproduced content of the projector 100b to each other. Accordingly, a feeling of strangeness of a viewer is required to be avoided by matching luminance, color tones, and update timings of the content between the projectors 100a and 100b. In this state, the requirement is achieved when the projectors 100a and 100b perform the coordinated operation in the process from step S404 to step S406.

In step S407, the controller 106 determines whether a reproduction ending time of the reproduction target track determined in step S400 has reached. When the determination is affirmative, the process proceeds to step S408, and otherwise, the process returns to step S401. Thereafter, the controller 108 executes the process of selecting content included in the reproduction target track again.

In step S408, the controller 108 determines whether all the tracks included in the schedule information read in step S400 have been reproduced. When the determination is negative, the process returns to step S400 and the same process is performed on the track which has not been reproduced. On the other hand, when the determination is affirmative, the controller 108 terminates this operation flow.

By the operation described above, the display system S may display content with image quality suitable for the single reproduction and image quality suitable for the multiple synchronization reproduction in the digital signage system including the single reproduction and the multiple syhchronization reproduction in a mixed manner.

### Effects of Display System S of Embodiment

As described above, when the controller 108 of the projector 100a in the display system S obtains content to be displayed in the plurality of projectors 100, the content is displayed in accordance with the first reproduction condition so that an image of quality the same as quality of an image of the projector 100b is viewed. Furthermore, when obtaining content for the single display, the controller 108 displays the content in accordance with the second reproduction condition which different from the first reproduction condition. By this, in a case where content to be displayed in a plurality of projectors is displayed, even when the different projectors have different capabilities, the content may be displayed as if images of the same image quality are displayed. Furthermore, when content is displayed in the projector 100, an image may be displayed making the most of the capability of the projector 100.

### First Modification

The object of the present disclosure may be achieved when a storage medium which records program codes of software which realizes the functions described in the foregoing embodiment is supplied to an electronic device having a function of displaying content in a display unit. Here, a computer (or a CPU or an MPU) including a controller of the electronic device to which the recording medium is suppled reads the program codes stored in the storage medium and executes a display control method based on the read program codes. In this case, the program codes read from the storage medium realize the functions of the embodiment described above, and the program codes and the storage medium which stores the program codes are also included in the present technique.

Examples of the storage medium which supplies the program codes include a flexible disk, a hard disk, an optical disc, a magneto-optical disc, a CD-ROM, a CD-R, a magnetic tape, a nonvolatile memory card, and a ROM.

The present technique further includes a case where an operating system (OS) operating in the electronic device executes a portion of or all the process in accordance with an instruction of the program codes described above and the functions described in the foregoing embodiment are realized by the processing.

The present technique further includes a case where the program codes read from the recording medium are written in a memory included in a function expansion board inserted into the electronic device or a function expansion. unit connected to toe computer and the functions described in the foregoing embodiment are realized. In this case, a CPU or the like included in the function expansion board or the function expansion unit executes a portion of or all the actual process in accordance with an instruction of the program codes.

### Second Modification

Although the case where the first reproduction condition used in the multiple reproduction is determined in accordance with a value input by the user in advance is described as an example in the description above, the first reproduction condition may be determined in other ways. For example, the controller 108 may determine the first reproduction condition in accordance with an image obtained by imaging content projected by another projector.

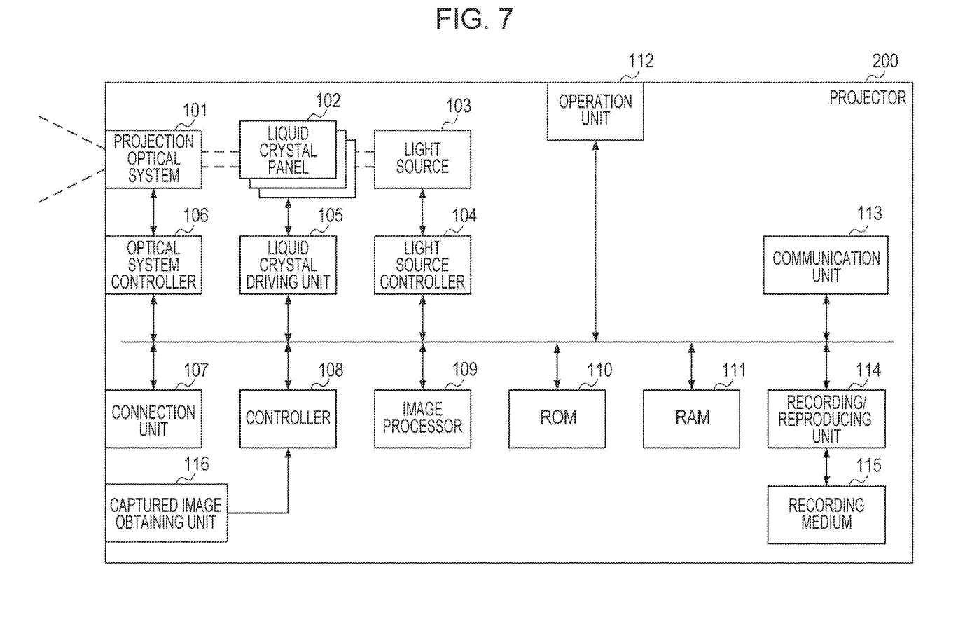

FIG. 7 is a diagram illustrating a configuration of a projector 200 according to a second modification. The projector 200 illustrated in FIG. 7 is the same as the projector 100 illustrated in FIG. 2 except that the projector 200 further includes a captured image obtaining unit 116. The captured image obtaining unit 116 is a camera, for example, which transmits a captured image to the controller 108. The captured image obtaining unit 116 may obtain a captured image from an external camera.

It is assumed that a display system S includes projectors 200a and 200b in this modification. A controller 108 of the projector 200a compares an image displayed by the projector 200a with an image displayed by the projector 200b using a captured image obtained from the captured image obtaining unit 116. Thereafter, the controller 108 of the projector 200a controls a color tone, luminance, and a frame rate in accordance with a result of the comparison so that an image of quality the same as that of the image displayed by the projector 200b may be displayed. In this case, the controller 108 changes the luminance or the frame rate so that, among the images displayed by the plurality of projector 200, luminance of an image having lower luminance or a frame rate of an image of lower frame rate is realized. The controller 106 of the projector 200a may control luminance or a frame rate so that an image of quality the same as that of the image displayed by the projector 200b set as a master in the plurality of projectors 200 is displayed.

### Third Modification

Although the case where the display system S includes the two projectors 100 is described as an example in the foregoing description, the number of projectors 100 may be three or more. Also in this case, RAMs 111 of the projectors 100, for example, store setting values of a first reproduction condition corresponding to a color tone, luminance and a frame rate which are set by a user in advance. Thereafter, a controller 108 displays content in accordance with the setting values of the first reproduction condition when the content is simultaneously displayed by three projectors.

### Fourth Embodiment

Although the case where the display system S includes a plurality of protectors 100 is described in the foregoing embodiment, the display system S may include other display devices instead of the projectors 100. For example, the display device may be a display which displays an image in a screen of the display device.

The forgoing description is made based on the embodiment of the present disclosure and the modifications. An embodiment generated by arbitrarily combining the embodiment and the modifications is also included in embodiments of the present disclosure. Effects of the new embodiment generated by the combination include the effects of the original embodiment. The technical range of the present disclosure is not limited to the range described in the foregoing embodiment, and various modifications and changes may be made within the scope of the disclosure.

While the present disclosure has been described with reference to exemplary embodiments, the scope of the following claims are to be accorded the broadest interpretation so as to encompass all such modifications and equivalent structures and functions.

This application claims the benefit of Japanese Patent Application No. 2016-138204 filed Jul. 13, 2016, which is hereby incorporated by reference herein in its entirety.

What is claimed is:

1. A display device comprising:
a content obtaining unit configured to obtain content; and
a display controller configured to display, when the content obtaining unit obtains the content to be displayed by a plurality of display devices, the content in a display unit in accordance with a first reproduction condition so that an image of quality the same as quality of an image displayed by another display device which displays the content at the same timing is viewed, and to display, when the content obtaining unit obtains the content to be displayed by a di play device, the content in the display unit in accordance with a second reproduction condition which is different from the first reproduction condition.

2. The display device according to claim 1, wherein the display controller displays, when the content obtaining unit obtains the content to be displayed by a plurality of display devices, the content in a first frame rate corresponding to the first reproduction condition in the display unit, and displays, when the content obtaining unit obtains the content to be displayed by a display device, the content in a second frame rate corresponding to the second reproduction condition in the display unit.

3. The display device according to claim 2, wherein the display controller uses, when the content obtaining unit obtains the content to be displayed by a plurality of display devices and when a maximum frame rate usable when the other display device displays the content is lower than a maximum frame rate usable when the display device displays the content, the maximum frame rate usable by the other display device as the first frame rate.

4. The display device according to claim 2, wherein the display controller uses, when the content obtaining unit obtains the content to be displayed by a display device, maximum frame rate usable when the display device displays the content as the second frame rate.

5. The display device according to claim 1, wherein the display controller displays, when the content obtaining unit obtains the content to be displayed by a plurality of display devices, the content in first image quality corresponding to the first reproduction condition in the display unit, and displays, when the content obtaining unit obtains the content to be displayed in a display device, the content in second image quality corresponding to the second reproduction condition in the display unit.

6. The display device according to claim 1, further comprising:
a storage unit configured to store the first reproduction condition to be used by the display controller when the content obtaining unit obtains the content to be displayed by a plurality of display devices and the second reproduction condition to be used by the display controller when the content obtaining unit obtains the content to be displayed by a display device.

7. The display device according to claim 1, further comprising:
an input reception unit configured to receive input of setting values corresponding to the first reproduction condition.

8. The display device according to claim 1, further comprising:
a captured image obtaining unit configured to obtain a captured image of a screen in which the other display device displays the content,
wherein the display controller determines the first reproduction condition based on the captured image.

9. The display device according to claim 1, further comprising:
a communication unit configured to receive status information associated with a status of the other display device from the other display device,
wherein the display controller displays the content in the display unit in accordance with the status information received by the communication unit when the content is displayed in the display unit in accordance with the first reproduction condition.

10. The display device according to claim 1, wherein the display controller determines whether the content is an image to be displayed in a plurality of display devices or an image to be displayed in a display device in accordance with information associated with the content.

11. The display device according to claim 1,
wherein the content obtaining unit obtains a plurality of content, and
the display controller displays the content selected from among the plurality of content in the display unit in accordance with a predetermined schedule for displaying the plurality of content in the display unit.

12. The display device according to claim 1, wherein the display controller performs time synchronization with the other display device before displaying the content in the display snit in accordance with the first reproduction condition.

13. The display device according to claim 1, wherein the display controller transmits an instruction for displaying the content to the other display device before the content is displayed in the display unit and displays the content in the display unit when a predetermined period of time has elapsed after the instruction is transmitted.

14. The display device according to claim 13, wherein the display controller displays the content in the display unit when the content has been decoded and when a notification indicating that the content has been decoded is received from the other display device which has received the instruction.

15. A display control method comprising:
obtaining content; and
displaying, when the content to be displayed by a plurality of display devices is obtained, the content in a display unit in accordance with a first reproduction condition so that an image of quality the same as quality of an image di played by another display device which displays the content at the same timing is viewed, and displaying, when the content to be displayed by a display device is obtained, the content in the display unit in accordance with a second reproduction condition which is different from the first reproduction condition.

16. A display system comprising:
a first display device; and
a second display device which communicates with the first display device,
wherein the first display device includes:
a content obtaining unit configured to obtain content, and
a display controller configured to display, when the content obtaining unit obtains the content to be displayed by a plurality of display devices, the content in a display unit in accordance with a first reproduction condition so that an image of quality the same as quality of an image displayed by another display device which displays the content at the same timing is viewed, and to display, when the content obtaining unit obtains the content to be displayed by a display device, the content in the display unit in accordance with a second reproduction condition which is different from the first reproduction condition.
